(19) United States
(12) Patent Application Publication
(10) Pub. No.: US 2016/0369158 A1
(43) Pub. Date: Dec. 22, 2016

(54) NANOFLUIDS FOR OIL RECOVERY FROM TIGHT LIGHT OIL RESERVOIRS AND METHODS OF THEIR USE

(71) Applicant: Petroraza SAS, Antioquia (CO)

(72) Inventor: Jose Edgar Patiño, Antioquia (CO)

(21) Appl. No.: 15/185,978

(22) Filed: Jun. 17, 2016

Related U.S. Application Data
(60) Provisional application No. 62/182,093, filed on Jun. 19, 2015.

(51) Int. Cl. C09K 8/58; E21B 49/08; E21B 43/267; E21B 43/26

(52) U.S. Cl. CPC C09K 8/58; E21B 43/26; E21B 49/086; E21B 43/267; C09K 2208/10

(57) ABSTRACT

Novel nanoparticle catalysts comprising alumina nanoparticles doped with silicon, nanofluids containing the nanoparticle catalysts, processes for their preparation, as well as methods of their use in treating light tight oil wells having fractures and the oils produced by the wells post are disclosed. The novel nanocatalysts are useful, inter alia, improving well production, extending the time between fracturings, reducing well treatment costs associated with improving well production and or reducing equipment down time.

### CROSS REFERENCE TO RELATED APPLICATIONS

This application claims the benefit of U.S. Provisional Application Ser. No. 62/182,093 filed Jun. 19, 2015, the disclosure of which is hereby incorporated herein by reference in its entirety.

### FIELD OF THE INVENTION

The present invention relates to a new class of nanoparticles, nanoparticle compositions, fluids containing the nanoparticle compositions that assist in the recovery of tight light oil from previously fractured oil wells. The fractures typically originate in the oil well through any process known as “hydrofracturing” (or more commonly, “fracking”), or by natural geologically driven pressures. The present invention further relates to oils containing these nanoparticle compositions that are recovered from such wells, processes for the preparation of the nanoparticle compositions and for the fluids containing the nanoparticle compositions, as well as methods of their use, and products prepared by contacting the nanoparticles with tight light oil found in oil wells containing fractures. More particularly, this invention relates to nanoparticles, nanoparticle compositions, and fluids containing the nanoparticle compositions, that comprise silica on alumina nanoparticles, wherein the nanoparticles have asphaltene sorption properties that promote the coating of these particles with asphaltenes onto the particle surface in the fractures connected to the well in the presence of the tight light oil contained within the well.

### BACKGROUND OF THE INVENTION

Huge volatile oil reserves accumulate in the nanopores or mesopores of unconventional formations known as tight volatile oil reservoirs and/or liquid rich shale reservoirs. Typically a combination of horizontal well drilling and multi-stage hydraulic fracturing is used to produce oil from these volatile oil reserves. However, oil recovery from tight oil formations is less than about 15% of that which is estimated to be contained within the reserves. In other words, greater than 80 percent of the oil reserves in these formations remains non-extractable from these tight oil reservoirs because the existing methods are not capable of cost effectively recovering more than the current amounts of extracted oil.

Volatile tight oil, or light shale oil is a very light crude oil contained in underground formations like shale or tight sandstone. The flow of oil from matrix rock to wellbore is limited by fine grained nature of the rock, the cause for the term tight. This is characterized in a study of liquid rich tight reservoirs' productivity presented by Honarpour et al. entitled “Characterization of Critical Fluid PVT, Rock, and Rock-Fluid Properties-Impact on Reservoir Performance of Liquid Rich Shales”, Paper SPE 158042 presented at SPE Annual Technical Conference and Exhibition, San Antonio, Tex., USA, 8-10 Oct. 2012.) They reported incidence of decreased oil bubble point pressure, the changes in oil viscosity and GOR behavior, and effects of interfacial tension and relative permeability to oil.

Shoaib and Hoffman presented a study conducted to evaluate CO₂ flooding as an enhanced oil recovery method in the liquid rich tight reservoir in Elm Coulee field, Montana. They reported that continuously injecting CO₂ into that reservoir led to a recovery of 16 percent estimated oil reserve. See Shoaib, S. and Hoffman, B. T., “CO₂ Flooding the Elm Coulee Field.” Paper SPE 123176, presented at the SPE Rocky Mountain Petroleum Technology Conference, Denver, Colo., USA, 14-16 Apr. 2009.

Other researchers disclosed a method for improving oil recovery in a tight oil formation by injection of CO₂ in each producer oil well using the known technique of huff and puff. They reported enhanced oil recovery using the CO₂ huff and puff method. See Chen, C. et al., “Effect of Reservoir Heterogeneity on Improved Shale Oil Recovery by _{CO2} Huff-n-Puff”, Paper SPE 164553, presented at the Unconventional Resources Conference, The Woodlands, Tex., USA, 10-12 Apr. 2013.

Austad et al. evaluated the potential of using surfactants to enhance oil recovery from a low permeability reservoir. The experiments were conducted injecting alkyltrimethylammonium bromides in brine as surfactant solutions into the well. Based on their observations, it was concluded that additional oil was produced by using surfactants within the water flood. Austad, T. et al., Chemical Flooding of Oil Reservoirs Part 8. “Spontaneous oil expulsion from oil-and water-wet low permeable chalk material by imbibition of aqueous surfactant solutions.”, Colloids and Surfaces A: Physico. Eng. Aspects 137 (1-3): 117-129 (1998).

In U.S. Pat. No. 4,842,065, McClure disclosed that injecting alternating surfactant slugs and water into a well improved oil recovery in fractured formations. In McClure's method, the injection cycle was repeated until the formation was depleted of oil.

Hoffman et al. evaluated different options of gas injection such as methane or nitrogen for increasing the oil recovery for shale oil reservoirs. See “Comparison of Various Gases for Enhanced Recovery from Shale Oil Reservoirs.” Paper SPE 154329 presented at the Eighteenth SPE Improved Oil Recovery Symposium, Tulsa, Okla., USA, 14-18 Apr. 2012.

Numerous methods have been evaluated in attempts to overcome difficulties with diminishing production rates and inability to extract a majority of contained oil from mesoporous tight oil formations. In the completion and operation of oil wells, gas wells, water wells, and similar boreholes, it is sometimes desirable to alter the producing characteristics of the formation by treating the well. It often becomes necessary to stimulate hydrocarbon flow in order to attain economical feasible production rates, or to increase declining production rates. The technique frequently used to stimulate wells in such a manner is termed “fracturing”, and refers to a method of pumping a fluid into the well until the pressure increases to a level sufficient to fracture the subterranean geological formation, resulting in cracks in the formation. These cracks are capable of carrying product to the well bore at a significantly higher flow rate. The fracturing is caused by injecting a viscous fracturing fluid, foam, or other suitable fluid at high pressure into the well to form fractures. As the well is being fractured, a particulate material, referred to as a “propping agent” or “proppant” is placed in the formation to maintain the fracture in a propped condition when the injection pressure is released. As the fracture forms, the proppants are carried into the well by suspending them in additional fluid or foam to fill the fracture with a slurry of proppants in the fluid or foam. Upon release of the pressure, the proppants form a “pack” which serves to hold open the fractures. The goal of using proppants is to increase production of oil and/or gas by providing a highly conductive channel in the formation. Choosing the correct proppant, therefore, is critical to the success of well stimulation. In hydraulic fracturing, proppant particles under high closure stress tend to fragment and disintegrate. It has been reported that this proppant disintegration can result in plugging of the interstitial flow passages in the propped interval and drastically reduce the permeability of the propped fracture. See U.S. Pat. No. 6,372,678. To resist this disintegration, stronger proppants have been sought out to reduce the disintegration of proppants believed by those in the art to be the cause of decreasing productivity of fractured wells over time.

For example, Watson et al. (U.S. Pat. No. 4,555,493) discloses aluminosilicate ceramic products as proppants for use in gas and oil well fracturing. The alumina to silica ratio in the calcined product reported as useful proppants is between 2.2 and 4.0. This Al/Si range, when iron content in the proppant is controlled is said to provide greater crush strength in the particles.

Sinclair et al. (U.S. Pat. No. 7,135,231) reported high strength composite particles composed of a series of incrementally applied resin microlayer coatings to a range of particles to reinforce the particles and provide greater strength and improve flow characteristics useful in delivering the proppant to the fracture.

Smith (U.S. Pat. No. 7,459,209) reported proppant particles with controlled buoyancy and crush strength to enhance transport into the formation increasing the amount of fracture area thereby increasing the mechanical strength of the reservoir with the intent of achieving increased flow rates or enhanced hydrocarbon recovery.

On the basis that disintegration of proppants and their migration in the well have contributed to reduced production over time, others have attempted to limit migration through the use of consolidation compositions. Weaver et al. (U.S. Pat. No. 7,819,192) report method comprising providing a consolidating agent emulsion composition that comprises an aqueous fluid, a surfactant, and a consolidating agent; and coating at least a plurality of particulates with the consolidating agent emulsion to produce a plurality of consolidating agent emulsion coated particulates for use in methods comprising: providing a treatment fluid comprising a consolidating agent emulsion comprising an aqueous fluid, an amine surfactant, and a consolidating agent; and introducing the treatment fluid into a subterranean formation.

Yet, in many instances, oil production rates initially enhanced by fracturing have a limited lifetime, and generally require multiple well fracturings, on a fairly routine schedule, to keep the oil flowing. This can cause down time on the well, resulting in lost revenues, and/or reduced production over time, as well as the added costs of additional proppants, some of which are expensive, and the expenses of high pressure re-fracturing of the existing wells. What is needed are compositions and methods that improve well production, extend the time between fracturings, reduce well treatment costs associated with improving well production. Increase well revenues, and/or reduce well down time. The present invention is directed to these and other important ends.

### SUMMARY OF THE INVENTION

Accordingly, the present invention is directed, in part, to silicon-doped alumina nanoparticle compositions having the following properties:

a BET surface area at a temperature of 77.35° K of from about 100 m²/g to about 500 m²/g;

a mesopore volume measured at a temperature of 77.35° K of from about 0.01 cm³/g to about 0.5 cm³/g; and

a pore diameter measured at a temperature of 77.35° K of from about 0.2 nm to about 2.5 nm;

wherein said composition comprises from about 0.05 to about 1 wt % silicon based on the weight of the composition.

In other embodiments, the present invention is directed to nanofluid compositions for treating tight oil reservoirs comprising a nanoparticle composition of the present invention; and

a hydrophilic carrier fluid.

In yet other embodiments, the present invention is directed to methods for treating tight light oil reservoir wells, said methods comprising:

identifying a tight light oil reservoir having an oil well with fractures connected to the well;

pressure-injecting an effective amount of a nanofluid composition in accordance with the disclosures herein into said oil well, said pressure sufficient to deliver at least some of the nanoparticle composition into said oil well fractures but insufficient to further fracture the oil well;

thereafter reducing the pressure applied to the well to deliver the nanoparticle composition to the oil well fractures; and

producing light oil from the oil well;
said light oil reservoir containing oil with an API gravity greater than 37°.

In still other embodiments, the present invention is directed to methods for treating tight light oil reservoir wells, said methods comprising:

identifying a tight light oil reservoir having an oil well with fractures;

pressure-delivering an effective amount of a nanoparticle composition in accordance with the disclosures herein into said oil well, said pressure sufficient to deliver at least some of the nanoparticle composition into said oil well fractures but insufficient to further fracture the oil well;

thereafter reducing the pressure applied to the well to deliver the nanoparticle composition to the oil well fractures; and

producing light oil from the oil well;
said light oil reservoir containing oil with an API gravity greater than 37°.

In yet other embodiments, the present invention is directed to light oils prepared by the processes of the present invention or prepared while employing the nanoparticle compositions or nanofluid compositions of the present invention to obtain oil from oil wells producing light oil, said light oil having an API gravity greater than 37°, said light oil further containing a silicon-doped alumina nanoparticle composition having the following properties:

a BET surface area at a temperature of 77.35° K of from about 100 m²/g to about 500 m²/g;

a mesopore volume measured at a temperature of 77.35° K of from about 0.01 cm³/g to about 0.5 cm³/g; and

a pore diameter measured at a temperature of 77.35° K of from about 0.2 nm to about 2.5 nm;
wherein said composition comprises from about 0.05 to about 1 wt % silicon based on the weight of the composition.

In yet other embodiments, the present invention is directed to light oils, wherein a silicon-doped alumina nanoparticle composition of the present invention has been removed from the light oil by further processing subsequent to the light oil's recovery from the oil well.

The foregoing and other objectives, features, and advantages of the invention will be more readily understood upon consideration of the following detailed description of the invention.

### BRIEF DESCRIPTION OF THE DRAWINGS

FIG. 1 illustrates an SEM picture of a silicon supported alumina nanoparticle composition of the presently disclosed invention comprising 0.15 wt % silicon.

FIG. 2 illustrates a closer SEM picture of an alumina nanoparticle composition of the presently disclosed invention.

FIG. 3 illustrates a closer SEM picture of an silicon supported alumina nanoparticle composition of the presently disclosed invention in comparison to its precursor nanoparticle (FIG. 2).

FIG. 4 illustrates the Amott cell apparatus used in Example 4.

FIG. 5 illustrates the Amott cell apparatus used in Example 5 equipped with a sample valve.

FIG. 6 illustrates the Permeability and Quality of Conventional and Unconventional Reservoirs as known to the ordinarily skilled artisan.

### DETAILED DESCRIPTION OF ILLUSTRATIVE EMBODIMENTS

As employed above and throughout the disclosure of the present invention, the following terms, unless otherwise indicated, shall be understood to have the following meanings.

As used herein, the term “BET surface area) refers to an established method (the Brunauer-Emmett-Teller method used for the determination of surface area. A convenient review reference for the BET method is written by Kenneth Sing (“The use of nitrogen adsorption for the characterization of porous materials”, Colloids and Surfaces, A:Physicochemical and Engineering Aspects 187-188 (2001) pages 3 to 9.

As used herein the term “mesoporous material” refers to a material that contains pores with diameters between 2 and 50 nm. The term “mesopore volume” refers to a measure of the volume of the mesopores in a mesoporous material. Mesopore volume can be conveniently measured by gas pyncnometry using helium or nitrogen gas. Porous materials are classified into several kinds by their size. According to IUPAC notation, microporous materials have pore diameters of less than 2 nm and macroporous materials have pore diameters of greater than 50 nm; the mesoporous category thus lies in the middle. Typical mesoporous materials include some kinds of silica and alumina that have similarly-sized fine mesopores.

As used herein, the term “nanoparticle” refers to fine particles having a particle size of less than or equal to 100 nanometers (i.e., less than or equal to 0.1 μm) as determined by the Pade-Laplace Method. The term “nanofluid” as used herein is used to define fluids, preferably hydrophilic fluids, containing nanoparticles.

As used herein, the term “tight oil reservoirs” or “tight oil formations” refers to low permeability tight formations containing gas and/or oil, and thus, useful sources for the production of such gas and/or oils. Tight oil formations include, for example, shales, carbonates, and/or sandstones. Known exemplary tight oil formations include the Bakken Shale, the Niobrara Formation, Barnett Shale, and the Eagle Ford Shale in the United States, R'Mah Formation in Syria, Sargelu Formation in the northern Persian Gulf region, Athel Formation in Oman, Bazhenov Formation and Achimov Formation of West Siberia in Russia, in Coober Pedy in Australia, Chicontepec Formation in Mexico, and the Vaca Muerta oil field in Argentina.

As used herein, the term “tight oil” (also known as “shale oil” or “light tight oil”, abbreviated LTO) refers to petroleum that is comprised of light crude oil contained in petroleum-bearing formations of low permeability, often shale or tight sandstone. Economic production from tight oil formations requires the same hydraulic fracturing and often uses the same horizontal well technology used in the production of shale gas.

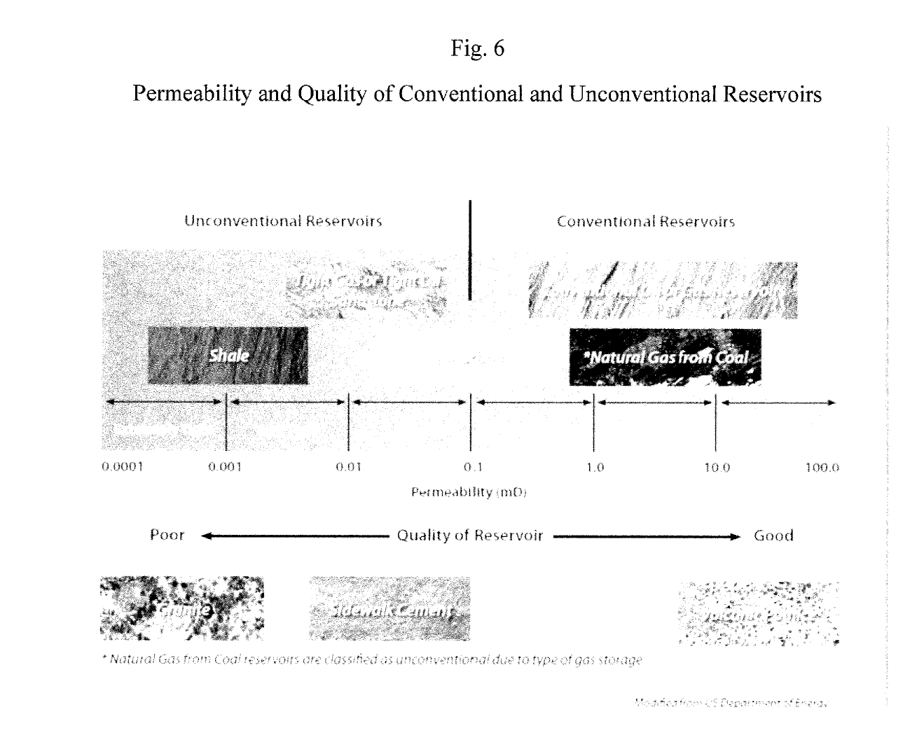

Although the terms shale oil and tight oil are often used interchangeably in public discourse, shale formations are only a subset of all low permeability tight formations, which include sandstones and carbonates, as well as shales, as sources of tight oil production. Within the United States, the oil and natural gas industry typically refers to tight oil production rather than shale oil production, because it is a more encompassing and accurate term with respect to the geologic formations producing oil at any particular well. EIA has adopted this convention, and develops estimates of tight oil production and resources in the United States that include, but are not limited to, production from shale formations. The ARI assessment of shale formations presented in the EIA report, however, looks exclusively at shale resources and does not consider other types of tight formations. See, “Technically Recoverable Shale Oil and Shale Gas Resources: An Assessment of 137 Shale Formations in 41 Countries Outside the United States”, EIA, 2013 (June), 76. See also FIG. 6.

As used herein, “hydraulic fracturing”, “hydrofracturing”, “hydrofracking” and “fracking” each refer to “is a well-stimulation technique in which rock is fractured by a hydraulically pressurized liquid made of water, sand or other proppant, and chemicals. Some hydraulic fractures form naturally—certain veins or dikes are examples. A high-pressure fluid (typically chemicals and sand suspended in water) is injected into a wellbore under pressure sufficient to create cracks in the deep-rock formations through which natural gas, petroleum, and brine will flow more freely. A hydraulic fracture is formed by pumping fracturing fluid into a wellbore at a rate sufficient to increase pressure at the target depth (determined by the location of the well casing perforations), to exceed that of the fracture gradient (pressure gradient) of the rock. The fracture gradient is defined as pressure increase per unit of depth relative to density, and is usually measured in pounds per square inch, per foot, or bars per meter. The rock cracks and the fracture fluid permeates the rock further extending the crack. Fractures are localized as pressure drops off with the rate of frictional loss, which is relevant to the distance from the well. Operators typically try to maintain “fracture width”, or slow its decline following treatment, by introducing a proppant into the injected fluid—a material such as grains of sand, ceramic, or other particulate, thus preventing the fractures from closing when injection is stopped and pressure removed. Consideration of proppant strength and prevention of proppant failure becomes more important at greater depths where pressure and stresses on fractures are higher. The propped fracture is permeable enough to allow the flow of gas, oil, salt water and hydraulic fracturing fluids to the well.” From Wikipedia, in an article on “hydraulic fracturing”.

As used herein, the term “effective amount” refers to an amount of a nanoparticle composition or nanofluid composition as described herein that may be effective to improve the production of oil from a well in its present state of production. For example, an effective amount of a nanoparticle composition or nanofluid composition may be sufficient to preferentially adsorb an amount of asphaltenes onto the nanoparticles delivered to the well production zone and/or associated fractures. If not adsorbed onto the nanoparticles, the asphaltenes could otherwise precipitate in fractures near or adjacent to the well production zone and inhibit or prevent at least a portion of the oil flow from the tight oil formation to the production zone.

As used herein, the term “API gravity” or “American Petroleum Institute gravity” is an inverse measure of the density of a petroleum liquid relative to that of water. Water weight is defined as the unit 10. Oils with API gravities less than 10 sink when placed in water; if they have API gravities greater than 10, they float on water. API gravity is used to compare the relative densities of petroleum liquids. The formula to obtain API gravity of petroleum liquids, from Specific Gravity (SG), is:

API gravity=[141.5\specific gravity]−131.5

Light crude oil is typically defined in the oil industry as having an API gravity higher than 31.1° API (less than 870 kg/m3).

As used herein. The term “substantially all” refers to an amount of a composition greater than 50% but less than 100%, and all combinations and subcombinations of ranges therein. In certain preferred embodiments, “substantially all” refers to greater than 55, 60, 65, 70, 75, 80, 85, 90, 95 or even 98%, but less than 100%, and all combinations and subcombinations of ranges therein.

The term “asphaltenes” as used herein refers to the fraction of oil, bitumen or vacuum residue that is insoluble in low molecular weight paraffins such as n-heptane or n-pentane, while being soluble in light aromatic hydrocarbons such as toluene, pyridine or benzene.

As used herein, “about” will be understood by persons of ordinary skill in the art and will vary to some extent on the context in which it is used. If there are uses of the term which are not clear to persons of ordinary skill in the art given the context in which it is used, “about” will mean up to plus or minus 10% of the particular term.

This invention is directed to, inter alia, the surprising and unexpected discovery of a new class of nanoparticle compositions and nanofluids comprising said nanoparticle compositions that improve oil well production rates in existing tight oil formation wells whose production has fallen off with time, processes for their preparation, and methods of their use, and products prepared by contacting the oil well production zones and/or proximal hydrofractures with the nanoparticle compositions and nanofluids. More particularly, this invention relates to silicon-doped alumina nanoparticle compositions, preferably with improved asphaltene sorption properties that may reduce precipitation of asphaltenes in fractures proximal to the well's production zone where the compositions are delivered. In some embodiments, the asphaltenes preferentially adsorb onto the nanoparticle compositions, which over time, may be carried with production oil to the wellhead, where their concentration may be measured. Increasing levels of the nanoparticle compositions contained in the produced oil, preferably in combination with declining production rates may assist the operator with decisions regarding the timing of any retreatment of the well with compositions or methods as disclosed herein.

Benefits of the nanoparticle compositions, nanofluid compositions, and methods of their use include one or more of the following: improved well production, extended times between well re-fracturings, reduced well treatment costs associated with improving well production, longer useful well life, increased well revenues, reduced well down time, as well as the lowered costs for additional proppant use, and reduced expenses of high pressure refracturing of the existing wells.

Accordingly, in certain embodiments of the present invention, the silicon-doped alumina nanoparticle compositions contain from 0.02 to 2 wt % silicon based on the weight of the composition, preferably from 0.03 to about 1.5%, with about 0.05 to about 1 wt % silicon based on the weight of the composition being more preferred. Certain preferred compositions further comprise alumina in a range of from about 98 to 99.95% by weight of the composition. Preferably the silicon is located at or near the surface of the alumina nanoparticles. The level of silicon on the alumina nanoparticle can be measured by SEM-EDS techniques known to those in the art.

In other preferred embodiments of the present invention, the silicon-doped alumina nanoparticle compositions have at least one of the following properties:

a BET surface area at a temperature of 77.35° K of from about 100 m²/g to about 500 m²/g;

a mesopore volume measured at a temperature of 77.35° K of from about 0.01 cm³/g to about 0.5 cm³/g; or

a pore diameter measured at a temperature of 77.35° K of from about 0.2 nm to about 2.5 nm. In more preferred embodiments, the compositions have at least two of the stated properties, with it being even more preferred when the silicon-doped alumina nanoparticle compositions have each of the following properties:

a BET surface area at a temperature of 77.35° K of from about 100 m²/g to about 500 m²/g;

a mesopore volume measured at a temperature of 77.35° K of from about 0.01 cm³/g to about 0.5 cm³/g; and

a pore diameter measured at a temperature of 77.35° K of from about 0.2 nm to about 2.5 nm.

In certain preferred embodiments of the nanoparticle compositions according to the invention, the aluminum oxide nanoparticles are doped with silica, in an amount of about 0.05% to about 1% by weight of composition, when the silica is measured as elemental silicon by known elemental measurement methods, preferably as measured by SEM-EDS. In certain preferred embodiments, the silica is present in a range of from about 0.05 to about 0.9% silicon, more preferably from about 0.06 to about 0.8, still more preferably from about 0.07 to about 0.7, more preferably still from about 0.08 to about 0.7, yet more preferably from about 0.08 to about 0.6, even more preferably from about 0.09 to about 0.5, and yet more preferably from about 0.09 to about 0.4, with from about 0.1 to about 0.3 by weight of composition being even more preferred. The silicon-doped alumina nanoparticle may be discussed in terms of the silicon content or silica content. Because the nanomaterial is calcined after its preparation in air at 650° C., it is quite reasonable to conclude that the silicon material that is supported on the nano-alumina is substantially all silica, referring to the oxygen added during calcination. However, the SEM-EDS method employed to determine silicon on the nanoparticle surface measures the content of silicon as the chemical element, because the method provides the elemental or atomic composition of the material. Thus, we indicate that, while the silicon is likely present on the surface of the alumina as silica, we report its level as elemental silicon based on the SEM-EDS analysis.

In certain embodiments, the nanoparticles of the present invention have a BET surface area at a temperature of 77.35° K of from about 100 m²/g to about 500 m²/g. Preferably, the nanoparticles have a BET surface area at a temperature of 77.35° K of from about from about 150 m²/g to about 450 m²/g, more preferably of from about 200 m²/g to about 400 m²/g, still more preferably from about 250 m²/g to about 400 m²/g, with from about 300 m²/g to about 400 m²/g being even more preferred.

In some embodiments, the nanoparticles have a mesopore volume measured at a temperature of 77.35° K of from about 0.01 cm³/g to about 0.5 cm³/g. Preferably, the nanoparticles have a mesopore volume in a range of from about 0.02 cm³/g to about 0.45 cm³/g; more preferably of from about 0.05 cm³/g to about 0.4 cm³/g; still more preferably of from about 0.075 cm³/g to about 0.35 cm³/g; more preferably of from about 0.1 cm³/g to about 0.35 cm³/g; yet more preferably of from about 0.1 cm³/g to about 0.3 cm³/g; with from about 0.15 cm³/g to about 0.25 cm³/g being yet more preferred.

In yet other embodiments, the nanoparticles have a pore diameter measured at a temperature of 77.35° K of from about 0.2 nm to about 2.5 nm. Preferably, the nanoparticles have a pore diameter in a range of from about 0.4 nm to about 2.4 nm; more preferably of from about 0.6 nm to about 2.3 nm; still more preferably of from about 0.7 nm to about 2.2 nm; yet more preferably from about 0.8 nm to about 2.1 nm; more still preferably from about 0.9 nm to about 2.1 nm; with from about 1 nm to about 2 nm being even more preferred.

In still other embodiments, the nanoparticles have an average particle size (diameter) of from about 10 to about 400 nm, preferably, from about 20 to about 300 nm, more preferably from about 30 to about 250 nm, yet more preferably from about 40 to about 250 nm, even more preferably from about 50 to about 200 nm, still more preferably from about 75 to about 150 nm, with from about 80 to about 120 nm being even more preferred. It is further contemplated that all combinations and subcombinations of these average particle sizes are contemplated as part of the invention disclosed herein.

In some embodiments, the invention is directed to nanoparticle catalyst compositions as disclosed herein for use in oil well production methods, preferably for treating tight oil reservoirs and/or any wells associated with such tight oil reservoirs, said compositions comprising a silicon-doped alumina nanoparticle composition. Although the nanoparticles of the present invention may be delivered to the production zones of wells as a pure composition, or any that may be appreciated by the ordinarily skilled artisan once armed with the present disclosures, they are preferably delivered by any of the methods disclosed herein. Alternatively, it may be preferable to present the nanoparticles as the active ingredient in a nanofluid composition to assist in the delivery of the nanoparticles to the fractures in the well, preferably those fractures proximal to the well production zone. The invention thus further provides nanofluid compositions comprising a nanoparticle composition of the present invention. Preferably the nanoparticles are present in the nanofluid composition in an amount effective to improve production of a tight oil well after treatment with the nanofluid. Such nanofluids may also comprise a carrier fluid, more preferably a hydrophilic carrier fluid, more preferably wherein said hydrophilic carrier fluid comprises an alcohol. The nanofluid also optionally comprises other functional ingredients. The carrier fluid must be acceptable in the sense of being compatible with the other ingredients of the nanofluid composition and not deleterious to contained oil in the well, or the well itself, including, for example its casings, its production zone, or existing fractures and proppants provided therein.

In some embodiments, the invention is directed to nanofluid compositions, that may be used, inter alia, in methods for treating oil reservoirs, preferably for treating tight oil reservoirs, said compositions comprising a nanoparticle composition of the present invention and a carrier fluid. The carrier fluid is present at a level of at least about 50%, preferably at least about 55, 60, 65, 70, 75, 80, 85, 90, 95, or even 99% by weight of the composition, and all combinations and subcombinations thereof; more preferably at least about 80, 85, 90, 95, 96, 97, 98, 99 or even 99.9% by weight of the composition. In certain preferred embodiments, the carrier fluid is hydrophilic. When the carrier fluid is hydrophilic, it is preferably water or an alcohol, or mixture thereof, more preferably an alcohol. Exemplary alcohols include those containing one to three hydroxyl groups, preferably 1 to 2, more preferably 1. In certain preferred embodiments, the alcohol is a C₁ to C₄ alkanol, substituted or unsubstituted, wherein the substituent is preferably C₁ to C₄ branched or straight chain alkoxy. Exemplary alcohols with one hydroxyl include methanol, ethanol, 1-propanol, 2-propanol, 1-butanol, 2-butanol, 3-methyl-1-propanol, 2-methyl-1-propanol, 2-methyl-2-propanol and substituted derivatives thereof; alcohols with two hydroxyls include ethylene glycol, 1,2-propylene glycol, 1,3-propylene glycol, 1,2-butandiol, 1,3-butandiol, 1,4-butandiol, 2,3-butandiol, 2-methyl-1,2-propandiol, 2-methyl-1,3-propandiol, and substituted derivatives thereof; exemplary alcohols with three hydroxyl groups include glycerin, 1,2,3-butanetriol and 1,2,4-butanetriol. In some alternative embodiments, the alcohol is preferably methanol, ethanol or alkoxyethanol (preferably wherein the alkoxy is butoxy), still more preferably ethanol.

In certain embodiments, the nanofluids of the present invention comprise alumina nanoparticles, preferably silicon-doped alumina nanoparticles. The alumina nanoparticles or silicon-doped alumina nanoparticles have comparatively similar BET surface areas, mesopore volumes and/or pore diameters. In some embodiments, one or more, preferably two or more, more preferably, all three properties are substantially the same for the two materials. Moreover, the average particle diameters are typically substantially the same for the two materials; that is, the alumina nanoparticle and the silicon-doped alumina nanoparticle prepared from the alumina nanoparticle. In certain embodiments wherein the nanofluids comprise the alumina nanoparticles, preferably silicon-doped alumina nanoparticles, the nanoparticles are preferably present at a range of from about 0.1 to about 2% by weight of the nanofluid composition, more preferably, from about 0.15 to about 1.5% by weight, with from about 0.2 to about 1% by weight Being even more preferred.

In addition, in some embodiments wherein the carrier fluid is other than water or a fluid comprising water, the nanofluid composition further comprises water or a surfactant or combination thereof. When water is present in these embodiments, it is present at about 1% invention or less based on the weight of the composition. When a surfactant is present in the composition, it is preferably a non-ionic or anionic surfactant, or combination thereof. In embodiments when a surfactant is present, it is typically present in the range of up to about 10% by weight based on the weight of the composition, and all combinations and subcombinations thereof; preferably in the range of up to about 5% by weight. General types of surfactants include anionic salts of carboxylic acids, castor oil derivatives, alkylphenol ethoxylates, polysorbates, alkyl sulfate anionics, alkyl sulfonate anionics, straight chain and branched alkylbenzene sulfonates, alkyl diemthyl amine oxides, polyethoxylated alcohols, sorbitans, and Triton X100™ type surfactants. Exemplary solvents of these types include: potassium palmitate, polyoxyl castor oil (Cremophor™), nonylphenol ethoxylate (Tergitol™), sodium dodecyl sulfate, sodium lauryl sulfate, di-sodium ricinoleate sulfate, linear alkylbenzene sulfonate, branched akylbenzene sulfonate, lauryl dimethyl amine oxide, polyethoxylated alcohols, polyoxyethylene sorbitan, octoxynol (Triton X100™) and N, N-dimethyldodecylamine-N-oxide, and any combination thereof.

In some embodiments, the invention is directed to processes for preparing a silicon-doped alumina nanoparticle composition:
said process comprising:
   dry impregnating a calcined amorphous sodium aluminate precipitate with an aqueous alkaline solution of a water-soluble silicon compound;
   and
   drying and calcining the silicon impregnated precipitate;
wherein the dry impregnating, drying and calcining steps are each carried out for a time and under conditions sufficient to provide a calcined silica supported alumina nanoparticle composition, wherein the silica supported on alumina nanoparticle composition has at least one of the following properties:
   a BET surface area at a temperature of 77.35° K of from about 100 m²/g to about 500 m²/g;
   a mesopore volume measured at a temperature of 77.35° K of from about 0.01 cm³/g to about 0.5 cm³/g; and
   a pore diameter measured at a temperature of 77.35° K of from about 0.2 nm to about 2.5 nm.

In some preferred embodiments, the silica supported on alumina nanoparticle composition has at least two of the properties noted above, more preferably having all three properties. In certain other preferred embodiments, the composition comprises from about 0.05 to about 1 wt % silicon based on the weight of the composition.

In certain preferred embodiments, the silica supported alumina nanoparticle composition is a calcined silica supported alumina nanoparticle composition prepared by a process disclosed herein.

In certain preferred embodiments, the calcined amorphous sodium aluminate precipitate is prepared by a process disclosed herein.

In other preferred embodiments, the aqueous alkaline solution of a water-soluble silicon compound comprises sodium silicate, sodium hydroxide, water, and glycerin. In certain embodiments, the aqueous alkaline solution of a water-soluble silicon compound is prepared by dissolving a silicate salt, preferably sodium or potassium silicate, more preferably sodium silicate, in aqueous hydroxide, such as sodium or potassium hydroxide, or an ammonium hydroxide, preferably sodium hydroxide, more preferably 50% aqueous sodium hydroxide, for a time and under conditions to dissolve the silicate. Preferably, glycerin and/or water, more preferably both, are added to the aqueous silicate solution. The combined solution is then sonicated for from about 1 to about 12 hours, preferably from about 4 to about 8, more preferably about 5 to about 7 hours, and all combinations and subcombinations of time ranges therein. The temperature employed to prepare this sonicated solution is not critical. However, the sonication may be preferably carried out at a temperature of from 20 to about 80 degrees C., more preferably about 50 to about 80, still more preferably about 60 to about 80, with from 70 to about 80 degrees C. being even more preferred.

In certain preferred embodiments of the present nanoparticle compositions, processes and methods, the alumina nanoparticles are present in an amount of at least 98, more preferably, 98.5, still more preferably 99% or more by weight of nanoparticle as described herein.

Typically, the alumina nanoparticles are derived from aluminum metal or an aluminum containing compound that has been contacted with an aqueous alkaline material such as hydroxide, preferably potassium or sodium hydroxide, more preferably sodium hydroxide. While any aluminum compound capable of dissolution in aqueous base may be employed, in certain preferred embodiments, aluminum metal is used as the aluminum feedstock. In other alternately preferred embodiments, aluminum hydroxide is used. Once the aluminum or aluminum hydroxide is dissolved, it may be precipitated as an amorphous solid by re-acidification by adding an acid and monitoring the pH until it is in the range of from about 5.5 to about 6.9, preferably from about 5.8 to about 6.5. Preferably, the re-acidification may be accomplished by using gaseous CO2 bubbled slowly into the solution or by the use of an aqueous mineral acid such as sulfuric acid, preferably 10% w/w aqueous sulfuric acid, more preferably at room temperature. At this point the acid addition may be terminated and, after an appropriate amount of time to allow for settling (e.g., 6 to 48 hours), the aluminum precipitate may be isolated, for example, by decanting the supernatant, washing the precipitate with deionized water under slow agitation, repeating the settling/rinse steps and collecting the precipitate by filtration. The isolated precipitate may be used in the silicon impregnation step, preferably by an incipient wetness method of impregnation (also referred to at times as “dry impregnation”), after its drying and calcining. Once the aluminate precipitate has been dried and calcined, it is ready for the dry impregnation step with a silicon salt. Drying typically is carried out at a temperature in a range of about 150 to 250 degrees C. until the water has been removed. The precipitate is then calcined, preferably rotatory calcined at a temperature of from about 900 to about 1200 degrees C. for a time of from about 0.25 hours to about 5 hours, preferably from about 1 to about 2 hours.

In other preferred embodiments, the calcined sodium aluminate precipitate is dry impregnated with an aqueous solution of a water-soluble silicon salt by employing the incipient wetness method (IWM). Preferably, the water-soluble silicon salt comprises sodium silicate or potassium silicate or other known silicate salts. Typically in the IWM, the active silicon precursor is dissolved in an alkaline aqueous solution. Then the alumina nanoparticle composition is contacted with the aqueous solution of a water-soluble silicon salt, preferably sprayed onto the nanoparticles. Typically, the pore volume of the nanoparticles is the same as the volume of silicon-containing solution with which the nanoparticles are to be contacted. Capillary action draws the solution into the pores. The silicon supported nanoparticle composition can then be dried and calcined to drive off the volatile components within the solution, resulting in the silicon being deposited onto the nanoparticle on or near the nanoparticle surface. Alternatively, the precipitate may be prepared by any of the processes known to the ordinarily skilled artisan.

To remove any volatiles following impregnation by the incipient wetness method, the precipitate may be dried by heating for a period of time until the volatiles, such as water are removed. In certain preferred embodiments, the silicon supported nanoparticle composition is dried at a temperature in the range of from about 150 to about 250° C. for a time sufficient to remove substantially all of the water from the silicon supported nanoparticle composition, preferably for from about 1 to about 8 hours. These conditions are generally recognized by the skilled artisan as insufficient to calcine the silicon supported nanoparticle composition of the present invention.

In some other preferred embodiments of the processes described herein, the dried silicon supported nanoparticle composition is thereafter calcined in the presence of oxygen or air for a time and under conditions sufficient to provide the calcined catalyst. A variety of conditions sufficient to calcine the silicon supported nanoparticle composition are well known to the ordinarily skilled artisan. In certain more preferred embodiments of the present invention, the silicon supported nanoparticle composition is calcined at a temperature in the range of from about 500 to about 800° C., preferably from about 600 to about 700° C., for a time sufficient to calcine the catalyst, preferably for from about 0.5 to about 6 hours.

In some other embodiments, a nanofluid composition is prepared from the silicon-doped alumina nanoparticle composition by contacting it with a hydrophilic carrier fluid, said hydrophilic carrier fluid as disclosed herein, for a time and under conditions effective to provide the nanofluid composition. In certain preferred embodiments, the nanofluid composition is prepared by further contacting the nanofluid or its precursors with a surfactant or an amount of water (in addition to any that may comprise the hydrophilic carrier fluid), or both for a time and under conditions effective to provide the nanofluid composition.

As noted herein above, the present invention is also directed in part to methods for treating tight light oil reservoir wells, said methods comprising:

identifying a tight light oil reservoir having an oil well with fractures connected to the well;

pressure-injecting into said oil well an effective amount of a nanoparticle catalyst composition or nanofluid composition in accordance with the disclosures herein, said pressure sufficient to deliver at least some of the nanoparticle composition into said oil well fractures but insufficient to further fracture the oil well;

thereafter reducing the pressure applied to the well to inject the nanoparticle composition to the oil well fractures; and

producing light oil from the oil well.

In certain preferred embodiments of the nanoparticle catalyst compositions, nanofluid compositions, methods of catalyst or nanofluid preparation as well as methods of use for any of the aforementioned, said light oil reservoirs preferably contain oil with an API gravity greater than 37°. While any method for delivering a catalyst or nanofluid composition of the present invention would be appreciated by one of ordinary skill in the art once armed with the present disclosures, it is preferable to inject the catalyst or nanofluid compositions under pressure into or in proximity to the well's production zone and/or any existing well fractures therein. Injection pressures typically should be such that they are sufficient to deliver at least some of the nanoparticle composition into said fractures connected to the well but insufficient to further fracture the oil well. Without desiring to be held to theory, it is believed that by employing the catalyst or nanofluid compositions in an existing fractured tight oil reservoir well, the user can improve and/or extend improved oil production from the well without the need to further fracture the existing well in proximity to the production zone.

In certain embodiments of the methods of using the nanoparticle and/or nanofluid compositions of the present invention, the well is a horizontal well. Alternatively, it is a vertical well, as these terms are generally understood in the industry.

In some preferred embodiments of the methods of treating wells with compositions disclosed herein, the injecting comprises:

obtaining a coiled tube having a distil end and a proximate end;

inserting the coiled tube into the well so that the distil end is in proximity to a production zone in the oil well and the coiled tube is in fluid connectivity with the fractures connected to the well;

delivering (under pressure) the silicon supported nanoparticle composition or nanofluid composition containing such silicon supported nanoparticle composition as disclosed herein to a location within the well that is in proximity to said fractures under said pressure for a time sufficient to deliver at least some of the nanoparticle composition to the fractures connected to the well. Preferably, the pressure on the well is such that it is capable of delivering substantially all of the injected nanoparticle catalyst composition to fractures connected to the well.

The time required to deliver or inject at least some of the silicon supported nanoparticle composition or nanofluid compositions to the production zone may vary dependent on the physical or chemical conditions in the well, such as the type of rock, its porosity, the pressure of the formation, the physical characteristics of the contained oil, fluids, proppants and/or agents provided to the well to resist disintegration of proppants, and the like. Typically, the delivery or injection pressure on the well is maintained for a period of time sufficient to deliver at least a portion of the nanoparticle catalyst composition or nanofluid containing such catalyst composition to fractures connected to the well. Preferably, the pressure being maintained on the well is such that, when it is maintained for a period of time, it delivers substantially all of the injected nanoparticle catalyst composition to fractures connected to the well.

In some embodiments, once the nanofluid has been delivered to the production zone, it is beneficial to allow a certain amount of time (“soaking time”) at pressure to increase the effectiveness of nanoparticle delivery into the fractures of interest. The soaking time assists with the permeation of the carrier fluid into the formation with the added benefit of leaving in the fractures the nanoparticles of the present invention. Soaking time may be in the range of from about 1 hour to about 48 hours, preferably, from about 2 to about 24 hours, with from about 4 to about 12 hours being more preferred.

While it is typically preferable to maintain a pressure until substantially all of the silicon supported nanoparticle composition or nanofluid composition is delivered to fractures connected to the well, said pressure being sufficient to deliver at least some of the nanoparticle composition into said fractures but insufficient to further fracture the oil well, the delivery pressure may be reduced at any time during the process.

The amount of nanofluid that may be added to a well may also vary dependent on the physical or chemical conditions in the well, such as the type of rock, its porosity, the pressure of the formation, the physical characteristics of the contained oil, fluids, proppants and/or agents provided to the well to resist disintegration of proppants, and the like. By way of guidance, a well model may be used to calculate a radial coverage of fluid penetration in a region proximal to the well production zone, in view of the homogeneous space of pore volume in the reservoir's production zone and a given desired penetration by the nanofluid (such as 1 to 5 feet). Once the volume has been calculated, a comparable volume of the nanofluid is injected into the well at a rate that is sufficient to deliver at least some of the nanoparticle composition into said oil well fractures but insufficient to further fracture the oil well. The pressure required to further fracture the well is typically well understood from earlier leak-off testing on the formation. Each formation has a specific gradient fracture depending on the nature of the rock and the depth of the rock. Oil companies typically run a leak off test as soon as they drill in a new area. A “Leak-off test” is used to determine the pressure at which the rock in the open hole section of the well just starts to break down, i.e., fracture (or “leak off”). In this type of test the operation is terminated when the pressure no longer continues to increase linearly as the fluid is pumped into the well.

In some embodiments the compositions disclosed herein may be delivered to the well by the methods of treating wells with compositions disclosed herein. In some preferred embodiments, the compositions are injected into the well, the injecting comprising:

obtaining a coiled tube having a distil end and a proximate end;

inserting the coiled tube into the well so that the distil end is in proximity to a production zone in the oil well and the coiled tube is in fluid connectivity with the fractures connected to the well;

delivering (under pressure) the silicon supported nanoparticle composition or nanofluid composition containing such silicon supported nanoparticle composition as disclosed herein to a location within the well that is in proximity to said fractures under said pressure for a time sufficient to deliver at least some of the nanoparticle composition to the fractures connected to the well. Preferably, the pressure on the well is such that it is capable of delivering substantially all of the injected nanoparticle catalyst composition to fractures connected to the well.

Once the time estimated for maintaining pressure on the well to inject at least a portion of the nanoparticle catalyst composition, and/or any additional “soaking time” has been reached, the pressure applied to the well may be reduced to allow pressure gradient between the reservoir and production zone to begin moving oil in the direction of the production zone. The oil being produced may be monitored over time for production rate as well as analyzed for any nanoparticles that may become entrained in the produced oil. Accordingly, in some preferred embodiments, the methods further comprise reducing the pressure applied to the well after a time that was estimated for injecting at least a portion of the nanoparticle catalyst composition has been reached.

In some embodiments, the methods further comprise removing the coiled tube from the well after the nanoparticle composition is delivered to the fractures connected to the well, with or without additional soaking time, or after the applied pressure has been reduced, preferably both, and more preferably by first reducing the pressure and subsequently removing the coiled tube from the well.

In some other embodiments, it is advantageous to inject a preflush into the well production zone prior to injecting the nanoparticles or nanofluid compositions of the presently disclosed invention. One function of any preflush treatment step should be to assist in removal of any precipitated asphaltene buildup in the fractures and flowing channels over time. Accordingly, it is useful to employ a fluid in which asphaltenes are soluble. Exemplary solvents include but are not limited to toluene, xylene, aromatic naphtha and other aromatic organic solvents. The amount of fluid employed in the preflush is not critical, but may be similar to the volume of nanofluid to be added to the well thereafter. The preflush may be added at a pressure sufficient to deliver at least some of the nanoparticle composition into said fractures but insufficient to further fracture the oil well. Time of delivery is not critical, but is typically dictated by the amount of preflush to be added in view of the pressure being employed to deliver the preflush to the targeted production zone as well any intrinsic properties of the well that may impact the pressure of the formation. Once the preflush has been delivered to the production zone, it may be beneficial to allow a certain amount of time (“soaking time”) at pressure to increase the effectiveness of the preflush into the fractures of interest. The soaking time assists with the permeation of the preflush into the formation and may enhance the amount of asphaltenes solubilized in the oil prior to a subsequent treatment of the well with any of the nanoparticle compositions and/or nanofluids of the presently disclosed invention. Soaking time may be in the range of from about 1 hour to about 48 hours, preferably, from about 2 to about 24 hours, with from about 4 to about 12 hours being more preferred.

In certain embodiments, the methods for treating tight light oil reservoir wells further comprise:

periodically sampling oil produced from the oil well treated with said nanofluid composition or said silicon-doped alumina nanoparticle composition;

analyzing the oil for contained silicon-doped alumina nanoparticle composition; and

retreating the well when said a cumulative amount of entrained silicon-doped alumina nanoparticle composition reaches a predetermined level in said produced oil; said retreating comprising:

injecting an additional effective amount of said nanofluid composition or said silicon-doped alumina nanoparticle composition as disclosed herein into said oil well under pressure, said pressure sufficient to deliver at least some of, preferably substantially all of, the nanofluid composition or silicon-doped alumina nanoparticle composition into said fractures connected to the well but insufficient to further fracture the oil well;

reducing the pressure on the well; and

producing light oil from the oil well.

Sampling the oil to determine nanoparticle levels in produced oil may be carried out by any of a number of analytical procedures. Determining a time appropriate to retreat the well with additional preflush (optional), and/or silicon supported nanoparticle composition or nanofluids comprising silicon supported nanoparticle compositions may include consideration of any number of factors, for example, analysis of oil production in the well over time, the capacity of the fractures to hold the silicon-doped alumina nanoparticle compositions, and/or analysis and calculation of cumulative entrainment of the compositions as disclosed herein in the produced oil over time. A variety of methods may be used to analyze for entrained silicon supported nanoparticle composition in the produced oil. In each case it is important to analyze at different stages of production to obtain a reasonable amount of data for a return curve. For example, a first phase in well sampling may be carried out from about 24 to about 48 hours after the nanofluid or silicon-doped alumina nanoparticle composition treatment procedure has been completed on the oil well. It is possible for a significant amount of nanoparticles to be flushed out of the well in the early stages of production after the pressure has been reduced to the well. Accordingly, it can be important to identify the amount of particles that are entrained in the first 2 days. After this time, measurements should be run daily for the first week, weekly to complete sampling during the remainder of the first month, and monthly thereafter for rest of life treatment in each well. This will allow the analyst the data to build a nanoparticle return curve and to confirm the success of the well treatment.

One preferred method of analysis is to track the level of aluminum in the produced oils. However, other methods may be alternatively employed. To analyze for aluminum in the method noted above, small sample (50 ml) of produced fluids (including the light oil and other fluids in the crude from the well) is taken at a well head sampling valve. Aluminum content in the sample can be measured by using the DR 400 8326 Hach method after rinsing the sample with 25 ml of deionized water. Alternatively, aluminum may be directly measurement with a Ion meter, for example, the Metrohm 691 pH/Ion meter or the like.

Results of aluminum content in the sample can be then compared with previous measurements and the oil production rates from the well to assist in developing a timetable for a re-treatment in the well. Moreover, the behavior of residual nanoparticles in each well provides information for creating a model for retreatments in wells of each formation.

In certain other embodiments, the invention is directed to light oils prepared by the methods for treating tight light oil reservoir wells as disclosed herein. Preferably, the light oils have an API gravity greater than 37°. In certain preferred embodiments, the light oils have an API gravity greater than or equal to about 37°. In yet other preferred embodiments, the light oils have an API gravity less than or equal to about 50°. More preferably, the light oils have an API gravity greater than or equal to about 37° and less than or equal to about 50°. In other preferred embodiments, the light oils further contain a nanoparticle catalyst composition, preferably a silicon-doped alumina nanoparticle composition having one or more, preferably two or more, more preferably all of the following properties:

a BET surface area at a temperature of 77.35° K of from about 100 m²/g to about 500 m²/g;

a mesopore volume measured at a temperature of 77.35° K of from about 0.01 cm³/g to about 0.5 cm³/g; and

a pore diameter measured at a temperature of 77.35° K of from about 0.2 nm to about 2.5 nm; still more preferably, wherein the silicon-doped alumina nanoparticle composition comprises from about 0.05 to about 1 wt % silicon based on the weight of the composition.

In some preferred embodiments, the light oils in the reservoir further contain asphaltenes; more preferably wherein at least some, preferably substantially all, of the asphaltenes present in the reservoir's contained oil flowing to the production zone are adsorbed on the surface of the nanoparticle composition provided to the well.

In certain other preferred embodiments, the light oils produced by the methods herein disclosed and containing a nanoparticle catalyst composition, preferably a silicon-doped alumina nanoparticle composition, are further processed subsequent to the light oil's recovery from the oil well to remove at least some, preferably, substantially all, more preferably all but a de minimis quantity, and still more preferably all of the nanoparticle catalyst composition from the processed oil.

In some embodiments, The treatment down well may take place in the following fashion. This general upgrading procedure may be employed after a well has been drilled and completed, whether or not the well in currently in production. Prior to introducing the nanoparticle composition or nanofluids comprising the nanoparticle compositions as disclosed herein into the well, it is useful if the well is perforated within the target zones that contain oil. A volume of nanofluid or other treatment fluid containing the silicon supported nanoparticle composition to be added is calculated, based on a radial volume of usually 1-5 feet surrounding the well bore in the target zone. This volume is calculated for the effective pore volume based on the rock reservoir porosity. To pump the fluid into the well, it is advantageous in some embodiments to use a coiled tubing that runs through the well head and into position near the front of the perforations of target zone (pay zone) in the reservoir. Then, the nanofluid or other treatment fluids containing the silicon supported nanoparticle composition is injected or squeezed into the well by a capillary string or through use of a coiled tube and flows through the perforations into the target zones at a pressure higher than the formation pressure. Other methods are readily recognized by the skilled artisan once armed with the present disclosures. As used herein, the term “coiled tubing” or “coiled tube” refers to a continuous length of steel or composite tubing that is flexible enough to be wound on a large reel for transportation. The coiled tubing unit is typically composed of a reel with the coiled tubing, an injector, control console, power supply and well-control stack. The coiled tubing is injected into the existing production string, unwound from the reel and inserted into the well”. Target formations (called pay zones or target zones) absorb the fluid as it is being injected. The pumping rate is set so as not to reach or exceed the formation fracture pressure, a characteristic defined by the geology of the individual well. Once the volume of the fluid has been squeezed into the formation, injection ceases, the well is optionally maintained for a period of time (“soaking”) in a static condition (no oil removal) to allow the desired reaction to take place. An exemplary time for “soaking” is overnight (from about 6 to about 12 hours). During this time, the silicon supported nanoparticle composition is in contact with the crude oil in the formation at the temperature and pressure that are defined by the well itself. For example, in the Bakken Formation the temperature at reservoir condition can be about 241° F. and formation pressure is about 6840 PSI. (see D. Sanchez-Rivera, K. Mohanty, and M. Balhoff, “Reservoir simulation and optimization of Huff-and-Puff operations in the Bakken Shale,” Fuel, vol. 147, pp. 82-94, 2015.). After sufficient time has been allowed for the soaking, the well is reopened by decreasing the delivery pressure and fluids from the target zones (pay Zone) begin to flow back through the fractures to the production zone and onward to the surface. In certain preferred embodiments, the well is retreated with additional silicon supported nanoparticle composition after a time, preferably from about a few months after the most recent treatment to about a year, or even more after the most recent treatment with the silicon supported nanoparticle composition of the present invention.

The disclosures of each of the foregoing documents are hereby incorporated herein by reference, in their entireties.

The present invention is further described in the following examples. Excepted where specifically noted, the examples are actual examples. These examples are for illustrative purposes only, and are not to be construed as limiting the appended claims.

### EXPERIMENTAL SECTION

### Description of Vasco Scattering Technique Used for Size Measurement of Nanoalumina Particles

Measurement of the nano particle's size that was carried out using a “Particulate Vasco”, employing the technique of dynamic light scattering (DLS). A sample suspension is irradiated by a laser and the light scattered in a certain direction detected with high time resolution. From the fluctuation of the intensity of the scattered light, the mobility of the particles can be calculated and then again via the Stokes-Einstein formula, their size can be calculated. This technique allows very accurate measurements even in highly concentrated dispersions of nano particles in any liquid medium known even in dark liquids.

See the following web page foe more detail: http://www.cordouan-tech. com/en/products/physical-chemistry-analysis/particles-characterization/particle-size-analyzer-vasco.

### Description of Technique Used for Wt % Silicon Analysis of the Silicon Supported Nanoparticle Compositions

A sample (about 0.1 g) is affixed to the coupon for insertion into the SEM. The coupon containing the sample is dried at a temperature of 80 C for 2 hours. The sample is gold powder coated using a metallizing E5000 Sputter Coater which is employed because of the nanometric sample size to sputter the coat the samples, load inhibit, reduce thermal damage and improve secondary electron emission. This equipment allows the observation and characterization of materials on a nanometer scale.

### EXAMPLES OF THE PRESENT INVENTION

### Example 1

### Preparation of Calcinated Alumina Nanoparticles

Aluminum hydroxide (120 kg) is poured in a 2000 liter stainless steel settling tank containing 2% w/w sodium hydroxide solution (1000 kg) with gently agitation (60 RPM) for 1 hour to completely dissolve the aluminum hydroxide. 10% w/w sulfuric acid solution is slowly added to the basic aluminum hydroxide solution. The pH was monitored until the pH of the combined solution was 6.2±0.3. Amorphous aluminate precipitated from the acidified mixture. The mixture was allowed to continue to precipitate and settle for 48 hours; then the excess of liquid was slowly decanted. The precipitate was mixed with deionized water (800 kg) under slow agitation for 1 hour to rinse it and then allowed to settle and precipitate again from the mixture over a week (7 days). The excess liquid was slowly decanted, and the rinsing, decanting, settling process was repeated. The precipitated aluminate was collected and dried at 200° C. and then calcined for 1 hour in a rotator calcination oven at a temperature of from 900° C.-1200° C.

### Properties of the Amorphous Nanoalumina

NANO ALUMINA Before Impregnation with Silica Source

### Surface Area

Single point surface area at P/Po=0.251039747: 356.0359 m²/g
BET Surface Area: 366.6703 m²/g

### Pore Volume

Single point adsorption total pore volume of pores
less than 2.3417 nm diameter at P/Po=0.225977040: 0.163651 cm³/g

### Pore Size

Adsorption average pore width (4V/A by BET): 1.78527 nm

### Example 2

Anhydrous sodium silicate (0.15 grams) was dissolved in 50% sodium hydroxide (5 g) at 37° C. and gently stirred per 1 hour. Then, glycerin (0.15 grams, isolated from Jatropha oil (obtained from Petroraza (Colombia)) and deionized water (95 grams) were added to the solution and the temperature was increased to 75° C. in a water bath equipped with a sonicator. The silicate/glycerin solution was sonicated for 6 hours at 75° C., and subsequently placed in a spray nozzle.

Amorphous nano-alumina (99.85 grams, Example 1), and having a diameter ranging between 65 and 120 nm as measured by dynamic light scattering (VASCO)) was gently dispersed on a ceramic plate. Using the spray nozzle, the dispersed nano-alumina was wetted with the silicate/glycerin solution employing the incipient wetness method.

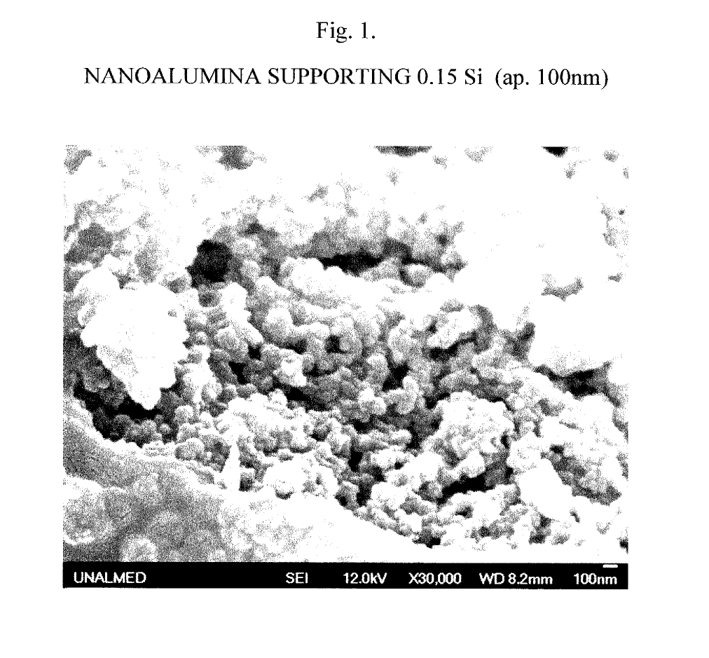

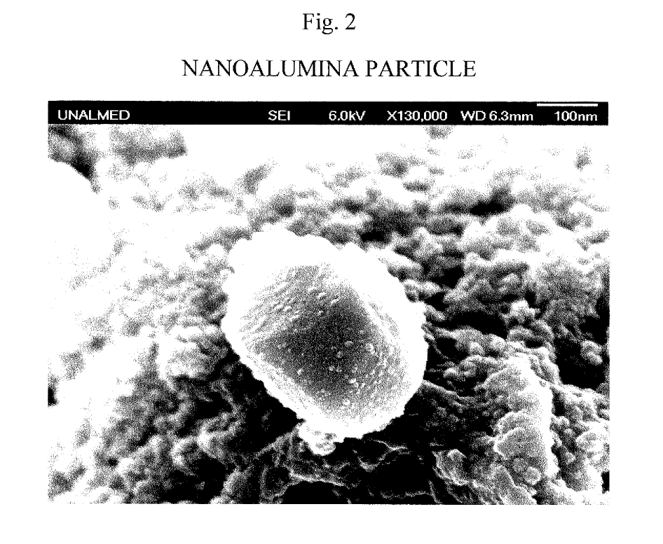

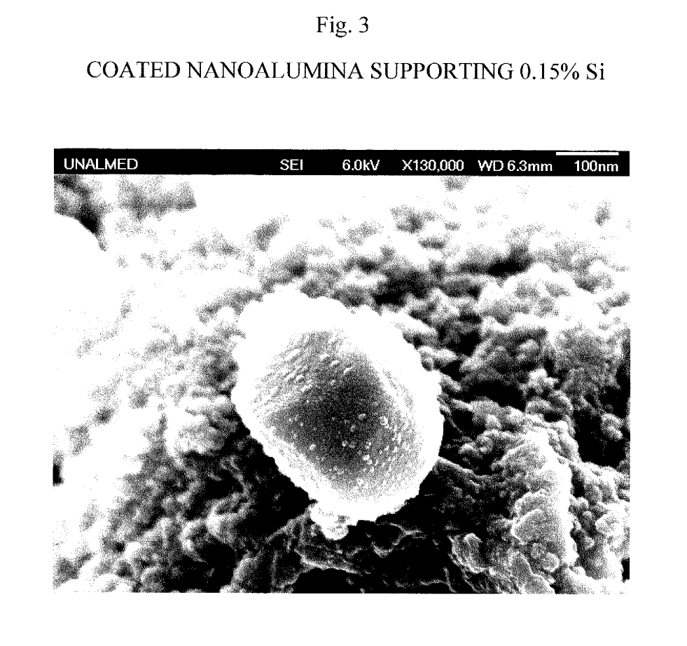

The wetted nano-alumina was dried for 2 hours at 287° C. and then calcined for 4 hours at 650° C. The diameter of the calcined nano-alumina particles containing 0.1 grams Si on the surface was measured by light dynamic scattering in a Vasco Particle size analyzer (Cordouan Technologies). The diameter of the calcined SI/Al nanoparticle was in the range of 80 to 120 nm. SEM-EDS was used to confirm the percentage of silica on the alumina support. The amount of nano-silica supported on nano alumina nanoparticles was about 0.15%. (FIGS. 1, 2, and 3)

### Example 3

A nanofluid containing silicon supported on alumina was prepared as follows. Ethanol (99.9 grams) was placed into a 200 mL beaker. Alumina nanoparticles (0.1 grams) supporting 0.15% Si (from Example 2) with an average size of 80-120 nm were added to the ethanol. The solution was sonicated for 2 hours at room temperature (about 20° C.).

To evaluate the effect of the nanofluid on Light oil viscosity, we injected the nanofluid (0.05 grams) as prepared above into a sample of Bakken light oil (8 grams). The light oil was obtained from a tight formation in Bakken, N. Dak. The oil viscosity was measured at 76° F. before and after the application of nanofluid. The initial light oil viscosity at 76° F. was determined to be 0.16 cp, as measured by a BROOKFIELD DV2T VISCOMETER using the spindle SC4-18. The DV2T Viscometer uses the methodology of rotational digital viscometers. The viscosity of the same oil after addition of the nanofluid at 76° F. was determined to be 0.14 cp.

### Example 4

### Light Oil Recovery

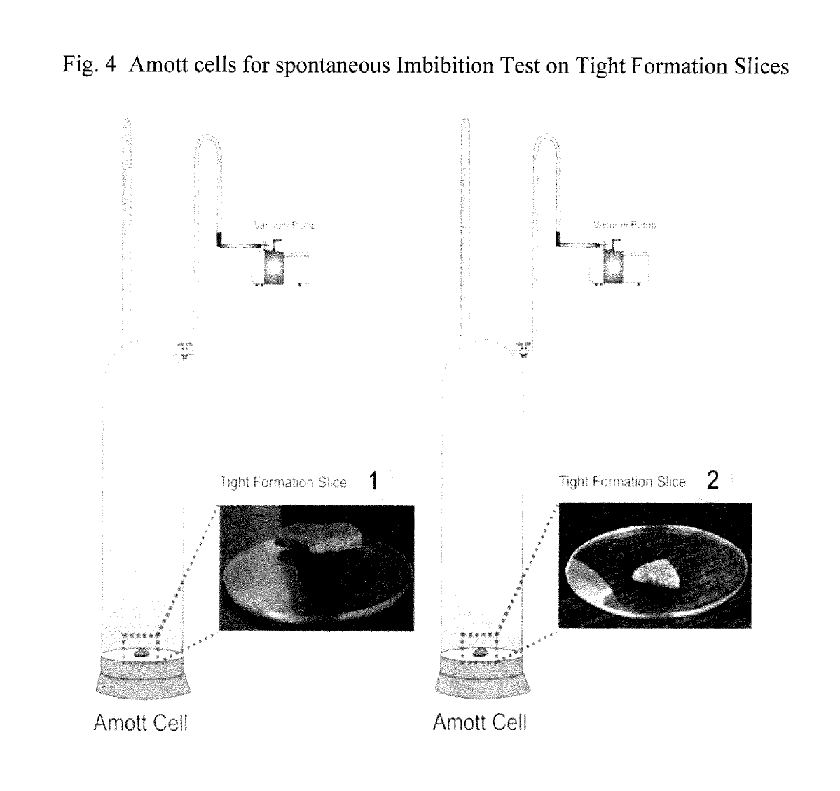

A preserved slice of core from a sample of a tight oil formation in Foot Hills Oil Basin in South America, having 5% of porosity and 0.1 and of permeability was divided into 2 slice sections in order to perform a spontaneous aqueous imbibition test assessed in an Amott cell. The 2 Core slice sections were weighed and recorded as core slice section 1 (14,2375 g), core and slice section 2 (9,8217 g. Each of the core slices was saturated at 47° C. with light oil (42° API) by soaking for 5 weeks in a sealed vessel to avoid oil evaporation. Then each of the core slice pieces was weighed and introduced into an Amott glass cell to evaluate spontaneous imbibition and light oil recovery with and without nanofluid present in the cell. The apparatus of Amott cells is shown in FIG. 4. Each Amott cell was filled in a following manner. The first Amott cell was filled with DI water (200 mL). The second Amott cell was filled with DI water (200 mL) and 0.5 w/w of a nanofluid containing alumina nanoparticles supporting 0.15% Si dispersed in ethanol.

The two Amott cells were placed in a water bath heated to 82° C. for 12 days. Oil expelled from each core slice piece was used to estimate light oil recovery from each sample of tight oil formation.

### Light Oil Recovery by Imbibition in Amott Cell Filled with Different Fluids

| | | % Light Oil Recovery in |
|---|---|---|
| | % Light Oil Recovery in | Amott cell 2 DI water + |
| Elapsed time | Amott Cell 1 | 0.5% Nanofluid containing |
| in hours | DI water | alumina nanoparticles 0.15% Si |
| 12 | 0.21 | 0.54 |
| 24 | 0.46 | 1.16 |
| 50 | 1.74 | 3.89 |
| 70 | 3.42 | 12.05 |
| 90 | 4.08 | 21.90 |
| 115 | 4.87 | 36.22 |
| 128 | 5.42 | 44.75 |
| 150 | 5.89 | 47.37 |
| 177 | 6.37 | 51.06 |
| 200 | 6.53 | 54.12 |
| 217 | 6.79 | 56.64 |
| 241 | 6.91 | 58.01 |
| 288 | 7.14 | 59.04 |

### Example 5

### Nanofluid B Preparation

Nanofluid B was prepared in the following manner. A 2000 ml plastic cylinder was charged with 989 grams of ethanol, alumina nanoparticles supporting 0.15% Si (1 gram) and butyl potassium palmitate (10 grams, a surfactant manufactured by Petroraza. The Petroraza surfactant employed (“butyl potassium palmitate” in the nanofluid preparation contained a mixture of butyl palmitate and potassium palmitate prepared from palmitic acid in the presence of water, butanol and KOH). The mixture was stirred for 1 hour and subsequently sonicated for 35 minutes.

Light Oil Recovery from a Tight Dolomitic Sample

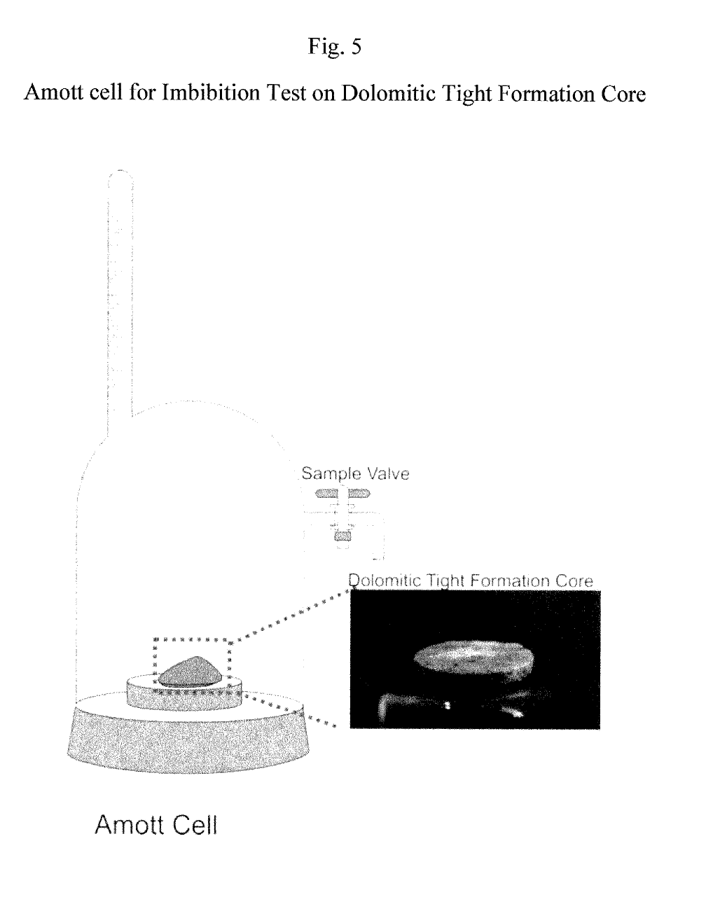

A preserved dolomitic core plug (23.4541 grams) from a tight oil formation from Ara-D shale basin in the Middle East at 9200 foot depth from the underground Dolomitic tight oil formation) was saturated in light oil by soaking for 4 weeks with a sample of light crude oil having an API gravity of 37° API and containing 3.72 percent weight by weight of Asphaltenes. Oil saturation was conducted in a sealed stainless steel vessel kept in an oven at 50° C. during the saturation step. Then, the oil saturated dolomitic core was weighed (26,0339 g) to determine the total oil content (2,5798 g) in the saturated core plug. The saturated core plug was placed in an Amott glass cell to evaluate imbibition and light oil recovery. The Amott cell used for this test was additionally equipped with a sampler valve, as shown in FIG. 5.

The Amott cell was filled with Nanofluid B (970 ml) containing 98.9% by weight of ethanol, 1000 parts per million of alumina nanoparticles supporting 0.15% Si, and 1% w/w of Butyl potassium palmitate. The Amott cell was placed in a water bath at 57° C. for 10 days. After five days of imbibition testing, the amount of oil expelled from the dolomitic core was determined by 1) cooling the Amott cell at 10° C. for 2 hours in a cool water bath (to avoid vapor emissions from the cell during sampling procedure); and 2) taking 3 ml of liquid for analysis. The Amott cell was reintroduced into the water bath at 57° C. to complete an additional 5 days of imbibition. After an additional 5 days, the cell was cooled in a cool water bath at 10° C. and a second sample of 3 ml of liquid was taken. The oil content of each sample was measured by absorbance in a spectrophotometer Genesys 10S-UV-VIS (Thermo Scientific) and comparing with a calibration curve.

| | | Light Oil Recovery from |
|---|---|---|
| | | Dolomitic core plug |
| | | By imbibition with a Nanofluid B |
| | | containing alumina nanoparticles |
| Elapsed time | Absorbance | in ethanol and Butyl potassium |
| in hours | at 600 nm | palmitate. |
| 120 | 0.351 | 57.99% |
| 240 | 0.451 | 97.10% |

These images were taken with the FE-SEM Instrument 6701 Jeol JSM-6701 FE-SEM Electronic Microscope” This ultra-high resolution JEOL JSM-6701F can help to observe fine structures, including multi-layered film and nano particles.

### Example 6

### Step A

A sample of light oil (500 g) with an API gravity of 40° API and containing 4.20% w/w of asphaltenes was poured in a 4570 HP-HT Parr reactor (manufactured by Parr Instrument Company, Moline Ill., USA). A clean stainless steel filter with an initial weight of 2.0943 g was placed in the filter holder connected to outlet line from the reactor, and the outlet valve was closed. The temperature in the vessel of Parr reactor was increased to 115° C. (analogous to oil reservoir conditions) and the reactor was pressurized to 1950 psi with natural gas of the following composition: methane 69 mol %, ethane 17 mol %, propane 4 mol %, butane 3 mol %, pentane 2 mol %, hexane 1 mol %, and carbon dioxide 4 mol %.

The reactor temperature was maintained at 115° C. of temperature and a pressure in the range of 1800 psi-1850 psi for 1 hour. After this time, the outlet valve of the Parr reactor that was connected to the filter holder was opened to allow the pressure to drop to atmospheric pressure. The light oil and gas were allowed to flow through the filter. The stainless steel filter was removed from the filter holder, rinsed 3 times with 25 ml each of warm n-heptane (at 45° C.). Then, the filter was dried under vacuum for 12 hours at 70° C., and weighed again, to obtain the amount of organic material precipitated from oil during depressurization. The filter and Parr reactor were cleaned for the next step of the test.

### Step B

A second sample (500 g) of the same light oil used in Step A was poured into the Parr reactor. Nano alumina nanoparticles (1.7 g) supporting 0.15% Si (as prepared in Example 2) with an average size of 80-120 nm were added and gently mixed with the oil sample. The clean stainless steel filter with a weight of 2.0943 g was placed in the filter holder connected to outlet line from the reactor, and the outlet valve was closed. The temperature in the vessel of Parr reactor was increased to 115° C. (analogous to oil reservoir conditions) and the reactor was pressurized to 1800 psi with the same natural gas used in Step A. The reactor temperature was maintained at 115° C. of temperature and a pressure in the range of 1800 psi-1850 psi for 1 hour. After this time, the outlet valve of the Parr reactor that was connected to the filter holder was opened to allow the pressure to drop to atmospheric pressure. The light oil and gas were allowed to flow through the filter. The stainless steel filter was removed from the filter holder, rinsed 3 times with 25 ml each of warm n-heptane (at 45° C.). Then, the filter was dried under vacuum for 12 hours at 70° C., and weighed again, to obtain the amount of organic material precipitated from oil during depressurization.

| | | Initial | Final | Weight of |
|---|---|---|---|---|
| | Description | weight | weight | Asphaltenes retained |
| Test | of test | of filter | of filter | in the Filter |
| Test - | Light Oil No | 2.0942 g | 7.1481 g | 5.0539 g |
| Step A | Nano catalyst | | | |
| Test - | Light Oil With | 2.0943 g | 2.1067 g | 0.0124 g |
| Step B | Nano catalyst | | | |

### Embodiment 1

A silicon-doped alumina nanoparticle composition having the following properties:

a BET surface area at a temperature of 77.35° K of from about 100 m²/g to about 500 m²/g;

a mesopore volume measured at a temperature of 77.35° K of from about 0.01 cm³/g to about 0.5 cm³/g; and

a pore diameter measured at a temperature of 77.35° K of from about 0.2 nm to about 2.5 nm;
wherein said composition comprises from about 0.05 to about 1 wt % silicon based on the weight of the composition.

### Embodiment 2

A nanoparticle composition according to Embodiment 1, wherein the BET surface area is from about 250 m²/g to about 400 m²/g.

### Embodiment 3

A nanoparticle composition according to Embodiment 1, wherein the BET surface area is from about 300 m²/g to about 400 m²/g.

### Embodiment 4

A nanoparticle composition according to any one of Embodiments 1 to 3, wherein the mesopore volume is from about 0.1 cm³/g to about 0.35 cm³/.

### Embodiment 5

A nanoparticle composition according to any one of Embodiments 1 to 3, wherein the mesopore volume is from about 0.15 cm³/g to about 0.25 cm³/.

### Embodiment 6

A nanoparticle composition according to any one of Embodiments 1 to 5, wherein the pore diameter is from about 0.6 nm to about 2.3 nm.

### Embodiment 7

A nanoparticle composition according to any one of Embodiments 1 to 5, wherein the pore diameter is from about 1 nm to about 2 nm.

### Embodiment 8

A nanoparticle composition according to any one of Embodiments 1 to 7, wherein said composition comprises from about 0.08 to about 0.7 wt % silicon based on the weight of the composition.

### Embodiment 9

A nanoparticle composition according to any one of Embodiments 1 to 7, wherein, wherein said composition comprises from about 0.1 to about 0.3 wt % silicon based on the weight of the composition.

### Embodiment 10

A nanofluid composition for treating tight oil reservoirs comprising:

a nanoparticle composition according to any one of Embodiments 1 to 9; and

a hydrophilic carrier fluid.

### Embodiment 11

A nanofluid composition according to Embodiment 10, further comprising a surfactant or water.

### Embodiment 12

A nanofluid composition according to Embodiment 10 or 11, wherein said nanoparticle composition is present at a range of from about 0.2 to about 1 wt % based on the weight of the nanofluid composition.

### Embodiment 13

A nanofluid composition according to any one of Embodiments 10 to 12, wherein said surfactant is present at a level of up to about 10 wt % or less based on the weight of the nanofluid composition.

### Embodiment 14

A nanofluid composition according to any one of Embodiments 11 to 13, wherein said water is present at a level of up to about 1 wt % or less based on the weight of the nanofluid composition.

### Embodiment 15

A method for treating tight light oil reservoir wells, said method comprising:

identifying a tight light oil reservoir having an oil well with fractures connected to the wells;

pressure-injecting an effective amount of a nanofluid composition according to any one of Embodiments 10 to 14 into said oil well, said pressure sufficient to deliver at least some of the nanoparticle composition into said oil well fractures connected to the well but insufficient to further fracture the oil well;

thereafter reducing the injection pressure applied to the well; and

producing light oil from the oil well;
said light oil reservoir containing oil with an API gravity greater than 37°.

### Embodiment 16

A method for treating tight light oil reservoir wells, said method comprising:

identifying a tight light oil reservoir having an oil well with fractures connected to the well;

pressure-delivering an effective amount of a silicon-doped alumina nanoparticle composition according to any one of Embodiments 1 to 9 into said oil well, said pressure sufficient to deliver at least some of the nanoparticle composition into said oil well fractures connected to the well but insufficient to further fracture the oil well;

thereafter reducing the delivering pressure applied to the well; and

producing light oil from the oil well;
said light oil reservoir containing oil with an API gravity greater than 37°.

### Embodiment 17

A method according to Embodiment 15, wherein the injecting comprises:

obtaining a coiled tube having a distil end and a proximate end;

inserting the coiled tube into the well so that the distil end is in proximity to a production zone in the oil well and the coiled tube is in fluid connectivity with the oil well fractures connected to the well;

delivering the nanofluid composition to a location within the well that is in proximity to said fractures connected to the well under said pressure for a time sufficient to deliver at least some of the nanoparticle composition to the oil well fractures connected to the well.

### Embodiment 18

A method according to Embodiment 17, wherein the injecting comprises:

obtaining a coiled tube having distil end and a proximate end;

inserting the coiled tube into the well so that the distil end is in proximity to a production zone in the oil well and the coiled tube is in fluid connectivity with the fractures connected to the well;
delivering the nanofluid composition to a location within the well that is in proximity to said fractures under said pressure for a time sufficient to deliver substantially all of the nanoparticle composition to the oil well fractures connected to the well.

### Embodiment 19

A method according to Embodiment 16, wherein the delivering of the silicon-doped alumina nanoparticle composition comprises:

obtaining a coiled tube having distil end and a proximate end;

inserting the coiled tube into the well so that the distil end is in proximity to a production zone in the oil well and the coiled tube is in fluid connectivity with the well fractures;

delivering the nanoparticle composition to a location within the well that is in proximity to said fractures under said pressure for a time sufficient to deliver at least some of the nanoparticle composition to the oil well fractures connected to the well.

### Embodiment 20

A method according to Embodiment 19, wherein the delivering of the silicon-doped alumina nanoparticle composition comprises:

obtaining a coiled tube having distil end and a proximate end;

inserting the coiled tube into the well so that the distil end is in proximity to a production zone in the oil well and the coiled tube is in fluid connectivity with the well fractures;

delivering the nanoparticle composition to a location within the well that is in proximity to said fractures under said pressure for a time sufficient to deliver substantially all of the nanoparticle composition to the oil well fractures.

### Embodiment 21

A method according to Embodiment 17 or 18, further comprising:

removing the coiled tube from the well after the nanofluid composition is delivered to the oil well fractures.

### Embodiment 22

A method according to Embodiment 19 or 20, further comprising:

removing the coiled tube from the well after the nanoparticle composition is delivered to the oil well fractures.

### Embodiment 23

A method according to any one of Embodiments 15, 17, 18, and 21 further comprising:

maintaining the well at said injection pressure after injection of the nanofluid composition;

for a period of time sufficient to deliver substantially all of the nanoparticle composition to the well fractures before reducing the well pressure.

### Embodiment 24

A method according to any one of Embodiments 16, 19, 20 and 22, further comprising:

maintaining the well at said delivering pressure after delivery of the nanoparticle composition;

for a period of time sufficient to deliver substantially all of the nanoparticle composition to the well fractures before reducing the well pressure.

### Embodiment 25

A method according to any one of Embodiments 15, 17, 18, 20, 21, and 23 further comprising:

periodically sampling oil produced from the oil well treated with said nanofluid composition;

analyzing the oil for contained nanoparticle composition; and

retreating the well when said a cumulative amount of entrained silicon-doped alumina nanoparticle composition reaches a predetermined level in said produced oil; said retreating comprising:

pressure-injecting an additional effective amount of said nanofluid composition into said oil well under pressure, said pressure sufficient to deliver at least some of the additional nanofluid composition into said oil well fractures but insufficient to further fracture the oil well;

thereafter reducing the pressure applied to the retreated well; and

producing further light oil from the retreated oil well.

### Embodiment 26

A method according to any one of Embodiments 16, 19, 20, 22, and 24 further comprising:

periodically sampling oil produced from the oil well treated with said silicon-doped alumina nanoparticle composition;

analyzing the oil for contained nanoparticle composition; and

retreating the well when said a cumulative amount of entrained silicon-doped alumina nanoparticle composition reaches a predetermined level in said produced oil; said retreating comprising:

pressure-injecting an additional effective amount of said silicon-doped alumina nanoparticle composition into said oil well under pressure, said pressure sufficient to deliver at least some of said additional silicon-doped alumina nanoparticle composition into said oil well fractures but insufficient to further fracture the oil well;

thereafter reducing the pressure applied to the retreated well; and

producing further light oil from the retreated oil well.

### Embodiment 27

A light oil prepared by the process according to any one of Embodiments 15 to 26, said light oil having an API gravity greater than 37°, said light oil further containing a silicon-doped alumina nanoparticle composition having the following properties:
a BET surface area at a temperature of 77.35° K of from about 100 m²/g to about 500 m²/g;

a mesopore volume measured at a temperature of 77.35° K of from about 0.01 cm³/g to about 0.5 cm³/g; and

a mesopore volume measured at a temperature of 77.35° K of from about 0.2 nm to about 2.5 nm;
wherein said composition comprises from about 0.05 to about 1 wt % silicon based on the weight of the composition.

When any variable occurs more than one time in any constituent or in any formula, its definition in each occurrence is independent of its definition at every other occurrence. Combinations of substituents and/or variables are permissible only if such combinations result in stable compositions, or provide workable parameters for the methods described herein.

It is believed the chemical formulas, abbreviations, and names used herein correctly and accurately reflect the underlying compounds, compositions, reagents and/or moieties. However, the nature and value of the present invention does not depend upon the theoretical correctness of these formulae, in whole or in part. Thus it is understood that the formulas used herein, as well as the chemical names and/or abbreviations attributed to the correspondingly indicated compounds, are not intended to limit the invention in any way, including restricting it to any specific form, to any specific isomer or compound, composition or specific parameter or property in method claims.

When ranges are used herein for physical properties, such as molecular weight, BET surface area, mesopore volume, pore diameter or chemical properties, such as chemical formulae, levels of reagents, contacting times of reagents, soaking times, drying and calcining times and temperatures, operation pressures and/or temperatures, API gravity properties, all combinations and subcombinations of ranges and specific embodiments therein are intended to be included.

The disclosures of each patent, patent application and publication cited or described in this document are hereby incorporated herein by reference, in their entirety.

The invention illustratively disclosed herein suitably may be practiced in the absence of any element which is not specifically disclosed herein. The invention illustratively disclosed herein suitably may also be practiced in the absence of any element which is not specifically disclosed herein and that does not materially affect the basic and novel characteristics of the claimed invention.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed:

1. A silicon-doped alumina nanoparticle composition having the following properties:
a BET surface area at a temperature of 77.35° K of from about 100 m²/g to about 500 m²/g;
a mesopore volume measured at a temperature of 77.35° K of from about 0.01 cm³/g to about 0.5 cm³/g; and
a pore diameter measured at a temperature of 77.35° K of from about 0.2 nm to about 2.5 nm;
wherein said composition comprises from about 0.05 to about 1 wt % silicon based on the weight of the composition.

2. A nanoparticle composition of claim 1, wherein the BET surface area is from about 250 m²/g to about 400 m²/g.

3. A nanoparticle composition of claim 2, wherein the BET surface area is from about 300 m²/g to about 400 m²/g.

4. A nanoparticle composition of claim 1, wherein the mesopore volume is from about 0.1 cm³/g to about 0.35 cm³/.

5. A nanoparticle composition of claim 3, wherein the mesopore volume is from about 0.15 cm³/g to about 0.25 cm³/.

6. A nanoparticle composition of claim 4, wherein the mesopore volume is from about 0.15 cm³/g to about 0.25 cm³/.

7. A nanoparticle composition of claim 1, wherein the pore diameter is from about 0.6 nm to about 2.3 nm.

8. A nanoparticle composition of claim 5, wherein the pore diameter is from about 1 nm to about 2 nm.

9. A nanoparticle composition of claim 8, wherein the pore diameter is from about 1 nm to about 2 nm.

10. A nanoparticle composition of claim 1, wherein said composition comprises from about 0.08 to about 0.7 wt % silicon based on the weight of the composition.

11. A nanoparticle composition of claim 9, wherein said composition comprises from about 0.1 to about 0.3 wt % silicon based on the weight of the composition.

12. A nanoparticle composition of claim 10, wherein said composition comprises from about 0.1 to about 0.3 wt % silicon based on the weight of the composition.

13. A nanofluid composition for treating tight oil reservoirs comprising:
a nanoparticle composition of claim 1; and
a hydrophilic carrier fluid.

14. A nanofluid composition of claim 13, further comprising a surfactant or water.

15. A nanofluid composition of claim 13, wherein said nanoparticle composition is present at a range of from about 0.1 to about 1 wt % based on the weight of the nanofluid composition.

16. A nanofluid composition of claim 14, wherein said surfactant is present at a level of up to about 10 wt % or less based on the weight of the nanofluid composition.

17. A nanofluid composition of claim 14, wherein said water is present at a level of up to about 1 wt % or less based on the weight of the nanofluid composition.

18. A method for treating tight light oil reservoir wells, said method comprising:
identifying a tight light oil reservoir having an oil well with fractures connected to the well;
pressure-injecting an effective amount of a nanofluid composition of claim 12 into said oil well, said pressure sufficient to deliver at least some of the nanoparticle composition into said fractures connected to the well but insufficient to further fracture the oil well;
thereafter reducing the injection pressure applied to the well; and
producing light oil from the oil well;
said light oil reservoir containing oil with an API gravity greater than 37°.

19. A method of claim 18, further comprising:
after the nanofluid composition has been pressure-injected, maintaining the well at the injection pressure for a period of time sufficient to deliver substantially all of the nanoparticle composition to the fractures connected to the well before reducing the well pressure.

20. A method of claim 18, wherein the injecting comprises:
obtaining a coiled tube having distil end and a proximate end;
inserting the coiled tube into the well so that the distil end is in proximity to a production zone in the oil well and the coiled tube is in fluid connectivity with the fractures connected to the well;
delivering the nanofluid composition to a location within the well that is in proximity to said fractures under said pressure for a time sufficient to deliver at least some of the nanoparticle composition to said fractures.

21. A method of claim 20, further comprising:
maintaining the well at said injection pressure after injection of the nanofluid composition;
for a period of time sufficient to deliver substantially all of the nanoparticle composition to the fractures connected to the well before reducing the well pressure.

22. A method of claim 21, further comprising:
removing the coiled tube from the well after the nanoparticle composition is delivered to the fractures connected to the well.

23. A method of claim 18, further comprising:
periodically sampling oil produced from the oil well treated with said nanofluid composition;
analyzing the oil for contained nanoparticle composition; and
retreating the well when said a cumulative amount of entrained silicon-doped alumina nanoparticle composition reaches a predetermined level in said produced oil; said retreating comprising:
pressure-injecting an additional effective amount of said nanofluid composition into said oil well under pressure, said pressure sufficient to deliver at least some of the additional nanofluid composition into said oil well fractures connected to the well but insufficient to further fracture the oil well;
reducing the pressure on the well; and
producing further light oil from the oil well.

24. A method for treating tight light oil reservoir wells, said method comprising:
identifying a tight light oil reservoir having an oil well with fractures connected to the well;
pressure-delivering an effective amount of a nanoparticle composition of claim 1 into said oil well, said pressure sufficient to deliver at least some of the nanoparticle composition into said fractures but insufficient to further fracture the oil well;
thereafter reducing the delivering pressure applied to the well; and
producing light oil from the oil well;
said light oil reservoir containing oil with an API gravity greater than 37°.

25. A method of claim 24, further comprising:
after the nanoparticle composition has been pressure-delivered, maintaining the well at the delivery pressure for a period of time sufficient to deliver substantially all of the nanoparticle composition to the fractures connected to the well before reducing the well pressure.

26. A method of claim 24, wherein the injecting comprises:
obtaining a coiled tube having distil end and a proximate end;
inserting the coiled tube into the well so that the distil end is in proximity to a production zone in the oil well and the coiled tube is in fluid connectivity with the fractures connected to the well;
delivering the nanoparticle composition to a location within the well that is in proximity to said fractures under said pressure for a time sufficient to deliver at least some of the nanoparticle composition to the fractures connected to the well.

27. A method of claim 26, further comprising:
maintaining the well at said delivery pressure after delivery of the nanoparticle composition;
for a period of time sufficient to deliver substantially all of the nanoparticle composition to the fractures connected to the well before reducing the well pressure.

28. A method of claim 27, further comprising:
removing the coiled tube from the well after the nanoparticle composition is delivered to the fractures connected to the well.

29. A method of claim 24, further comprising:
periodically sampling oil produced from the oil well;
analyzing the oil for contained nanoparticle composition; and
retreating the well when said a cumulative amount of entrained silicon-doped alumina nanoparticle composition reaches a predetermined level in said produced oil; said retreating comprising:
pressure-delivering an effective amount of said nanoparticle composition into said oil well under pressure, said pressure sufficient to deliver at least some of the additional nanoparticle composition into said fractures but insufficient to further fracture the oil well;
reducing the pressure on the well; and
producing further light oil from the oil well.

30. A light oil prepared by the process according to claim 18 said light oil having an API gravity greater than 37°, said light oil further containing a silicon-doped alumina nanoparticle composition having the following properties:
a BET surface area at a temperature of 77.35° K of from about 100 m²/g to about 500 m²/g;
a mesopore volume measured at a temperature of 77.35° K of from about 0.01 cm³/g to about 0.5 cm³/g; and
a pore diameter measured at a temperature of 77.35° K of from about 0.2 nm to about 2.5 nm;
wherein said composition comprises from about 0.05 to about 1 wt % silicon based on the weight of the composition.

31. The light oil according to claim 30, wherein the light oil further contains asphaltenes.

32. The light oil according to claim 31, wherein at least some of the asphaltenes are adsorbed on the surface of the nanoparticle composition.

33. The light oil according to claim 32, wherein the nanoparticle composition has been removed from the light oil by further processing subsequent to the light oil's recovery from the oil well.
